(19) United States
(12) Patent Application Publication
(10) Pub. No.: US 2025/0256957 A1
(43) Pub. Date: Aug. 14, 2025

(54) LOW-EMISSION POWER GENERATION SYSTEM AND METHOD

(71) Applicant: NUOVO PIGNONE TECNOLOGIE - S.R.L., Florence (IT)

(72) Inventors: Olaf STALLMANN, Florence (IT); Gianni ORSI, Florence (IT); Davide RASTELLI, Florence (IT)

(21) Appl. No.: 18/856,748

(22) PCT Filed: Apr. 20, 2023
(86) PCT No.: PCT/EP2023/025184

§ 371 Date: Oct. 14, 2024

(30) Foreign Application Priority Data
Apr. 21, 2022 (IT) 102022000007907
Apr. 14, 2023 (IT) 102023000007167

(51) Int. Cl. C01B 3/12; B01D 53/00; B01D 53/26; C01B 3/50; H01M 8/04089; H01M 8/0612; H01M 8/0668

(52) U.S. Cl. CPC C01B 3/12; B01D 53/002; B01D 53/265; C01B 3/506; H01M 8/04097; H01M 8/0618; H01M 8/0668; B01D 2256/16; B01D 2257/504; B01D 2257/80; C01B 2203/0283; C01B 2203/046; C01B 2203/0475

(57) ABSTRACT

The power generation system comprises a fuel cell unit adapted to generate electric power using a hydrocarbon-containing gas. A water-gas shift reactor is adapted to receive flue gas from the fuel cell unit and convert carbon monoxide contained in the flue gas into carbon dioxide and hydrogen. A cryogenic carbon dioxide capture unit is adapted to receive flue gas from the water-gas shift reactor and remove carbon dioxide therefrom. A recycle line recycles carbon dioxide-depleted flue gas to the fuel cell unit.

### TECHNICAL FIELD

The present disclosure concerns systems and methods for power generation. Specifically, disclosed herein are methods and systems for generating electric power from fossil fuels.

### BACKGROUND ART

Fossil fuels, specifically natural gas, are still major resources for the generation of mechanical and electric power. Fossil fuels are used in thermodynamic processes for producing thermal power and converting thermal power in mechanical or electric power. Thermodynamic cycles typically use natural gas in gas turbine engines which generate mechanical power through a Bryton cycle. The combustion of large amounts of fossil fuels generates carbon dioxide, which is released in the atmosphere. Carbon dioxide is a greenhouse effect gas, which is responsible for global warming and has therefore a highly detrimental environmental impact.

In recent years, in addition to attempts aimed at increasing the use of renew-able energy resources having no emissions, such as solar and wind energy, efforts have been made to reduce the amount of carbon dioxide released in the atmosphere by combustion of fossil fuels. Carbon capture and storage systems have been developed, aimed at removing carbon dioxide from flue gas produced by combustion of fossil fuels, prior to releasing the flue gas in the atmosphere. Carbon capture units have a negative impact on the overall efficiency of the power generation system, since they consume power. Carbon capture efficiency increases with the concentration of carbon dioxide in the flue gas. Efforts have therefore been made to develop systems and methods, which produce flue gas with a high concentration of carbon dioxide, to ameliorate the overall power efficiency of the system.

The above-mentioned efforts notwithstanding, a strong need still exists for a further reduction of emissions generated by the combustion of fossil fuels for the power generation purposes. Therefore, the development of new systems and methods adapted to reduce carbon dioxide emission and improve capture and storage thereof would be welcomed in the art.

### SUMMARY

To ameliorate the energetic efficiency of fuel-cell based power generation systems and reduce the carbon dioxide emissions thereof, according to the present disclosure a power generation system is provided, which comprises a fuel cell unit adapted to generate electric power using a hydrocarbon-containing gas, combined with a water-gas shift reactor adapted to receive flue gas form the fuel cell unit and convert carbon monoxide contained in the flue gas into carbon dioxide and hydrogen. A cryogenic carbon dioxide capture unit, is further provided, which is adapted to receive flue gas from the water-gas shift reactor and remove carbon dioxide therefrom. The system further includes a recycle line adapted to recycle carbon dioxide-depleted flue gas, and containing hydrogen, to the fuel cell unit.

The combination of hydrocarbon reforming, water-gas shift reaction, cryogenic carbon capture and removal and recycling of carbon dioxide-depleted flue gas containing hydrogen towards the fuel cell unit results in high percentage of CO₂ capture and high overall energy efficiency of the system, as will be better appreciated from the following description of embodiments.

The hydrocarbon (mainly methane) is converted into hydrogen and carbon monoxide in a hydrocarbon (methane) reforming section which broadly speaking forms part of the fuel cell unit. In some embodiments, the reforming section can be embedded in the fuel cell stack(s), i.e. the fuel cells can be designed such that hydrocarbon reforming is performed inside the fuel cell proper. In other embodiments, a separate hydrocarbon reforming section, upstream of the fuel cell stack(s) can be provided.

According to a further aspect, disclosed herein is a method for generating power from natural gas, the method comprising the following steps:
delivering a hydrocarbon-containing fuel to a fuel cell unit;
converting hydrocarbon in the hydrocarbon-containing fuel into carbon monoxide and hydrogen;
generating electric power in the fuel cell unit using the hydrogen and an oxidant, and producing a carbon monoxide-containing flue gas;
converting carbon monoxide in the flue gas into carbon dioxide and hydrogen through a water-gas shift reaction;
cryogenically capturing and removing carbon dioxide from the flue gas;
recycling carbon dioxide-depleted flue gas containing hydrogen to the fuel cell unit.

Further features and embodiments of the system and method of the present disclosure are outlined below, reference being made to exemplary embodiments shown in the drawings, and are outlined in the annexed claims.

### BRIEF DESCRIPTION OF THE DRAWINGS

Reference is now made briefly to the accompanying drawings, in which:

FIG. 1 is a simplified schematic of a system according to the present disclosure;

FIG. 2 is a first embodiment of a system according to the present disclosure;

FIG. 3 is a further embodiment of a system according to the present disclosure;

FIG. 4 is a further embodiment of a system according to the present disclosure;

FIG. 5 is a yet further embodiment of a system according to the present disclosure;

FIG. 6 is a flowchart summarizing the steps of a method according to the present disclosure;

FIG. 7 is a simplified schematic of a system according to the present disclosure in a further embodiment; and

FIG. 8 is an embodiment of a system according to FIG. 7.

### DETAILED DESCRIPTION

The system includes a fuel cell unit, in which hydrogen obtained from natural gas or another source of hydrocarbons, is oxidized with oxygen, for instance atmospheric oxygen. The flue gas generated by the fuel cell unit is processed in a cryogenic carbon capture unit (referred to also as cryogenic “carbon dioxide capture unit”) to remove carbon dioxide therefrom. Carbon dioxide-depleted flue gas is recycled towards the fuel cell unit, to use still unoxidized hydrogen contained therein. A water-gas shift reactor can be provided to process the flue gas from the fuel cell unit and convert carbon monoxide, generated by hydrocarbon reforming, into carbon dioxide, which is then removed from the flue gas in the cryogenic carbon capture unit.

A high carbon capture efficiency is achieved with a capture rate beyond 95% and reduced parasitic power consumption, which increases the overall energetic efficiency of the system.

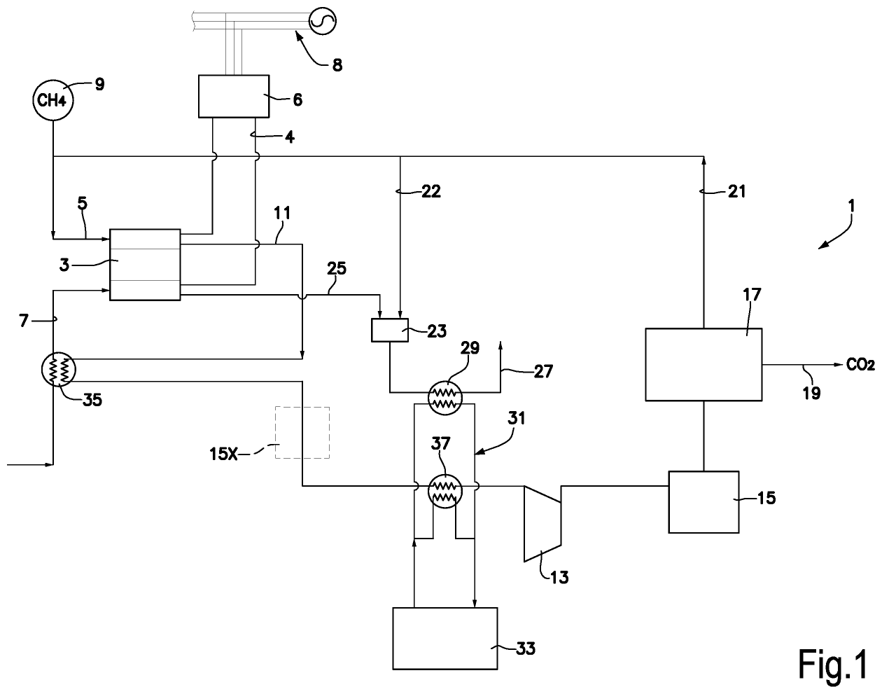

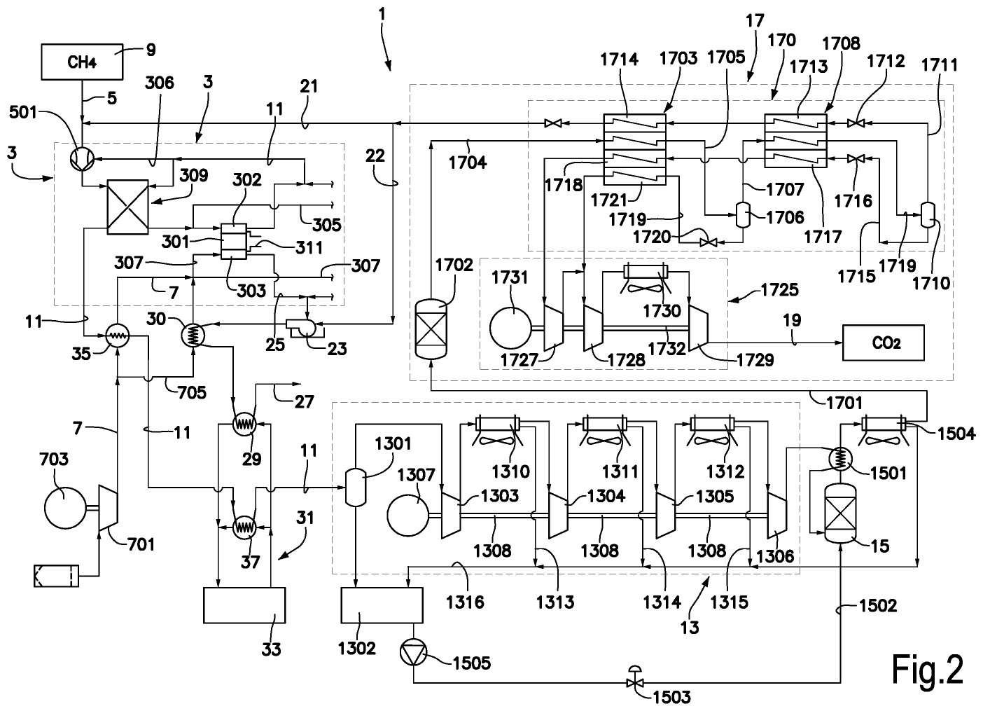

Turning now to the drawings, a simplified schematic of a system according to the present disclosure is shown in FIG. 1. More details of embodiments of the system and method for power generation and carbon dioxide capture will be described with reference to FIGS. 2 to 5.

A power generation system 1 shown in FIG. 1 includes a fuel cell unit 3, adapted to receive a fuel stream at 5 and an oxidant stream at 7. The fuel stream can be a stream of gaseous hydrocarbons, such as in particular natural gas. The fuel can be fed by a fuel source 9, for instance a source of methane (CH₄). The oxidant stream can be an oxygen-containing gas mixture, such as ambient air.

In the fuel cell unit 3 the fuel (e.g., methane) is converted by steam reforming into carbon monoxide and hydrogen, according to the following reaction:

CH₄+H₂O↔CO+3H₂ (1)

The gas stream resulting from the steam reforming is delivered to the anode of one or more fuel cell stacks of the fuel cell unit 3. The oxidant stream is delivered to the cathodes of the fuel cell stacks in the fuel cell unit 3. Hydrogen and oxygen from oxidant stream react in the fuel cell stacks to generate electric energy and flue gas.

Specifically, in some embodiments the following reactions take place at the anode and cathode of the fuel cell stacks:

anode reaction: 2H₂+2O₂⁻→2H₂O+4e⁻

cathode reaction: O₂+4e⁻→2O₂⁻

overall cell reaction: 2H₂+O₂→2H₂O (2)

The electrons (e⁻) generated at the anode circulate in an external circuit 4 towards the cathode and form the electric power produced by the fuel cell unit 3. DC electric current flowing in the external circuit 4 can be converted in AC electric current in a DC/AC converter 6. The converter 6 may deliver AC electric power to an electric power distribution grid 8.

The flue gas generated at the anodes of the fuel cell stacks is collected in a flue gas line 11 and contains residual un-reacted hydrogen (H₂), carbon monoxide (CO) and water (H₂O).

The flue gas from the fuel cell unit 3 is processed to convert the carbon monoxide into carbon dioxide and remove the carbon dioxide to obtain a carbon dioxide-depleted flue gas.

More specifically, flue gas from the anodes of the fuel cell stacks in the fuel cell unit 3 is compressed in a flue gas compression section 13 and processed in a water-gas shift reactor, to convert carbon monoxide and water into carbon dioxide and hydrogen according to the following reaction:

CO+H₂O↔CO₂+H₂ (3)

The water-gas shift reactor can be arranged downstream of the flue gas compression section 13 as shown at 15, or upstream thereof as shown at 15X in FIG. 1.

The system 1 further comprises a cryogenic carbon dioxide capture unit 17, also referred to as gas processing unit 17, which removes carbon dioxide from the flue gas that has been previously compressed and processed in the water-gas shift reactor 15, 15X. Carbon dioxide in gaseous, liquid or supercritical phase is removed at 19 and carbon dioxide-depleted flue gas is recycled along a recycle line 21 towards the fuel cell unit 3. Hydrogen contained in the recycled flue gas is exploited in the fuel cell unit 3 to generate further electric power.

To remove inert gases from the recycled stream of carbon dioxide-depleted flue gas, a fraction of the flowrate of recycled flue gas is withdrawn through a diverting line 22 from the recycle line 21 and delivered to a combustor 23. An oxidizer stream is fed to the combustor to oxidize the diverted flue gas, in particular to burn the hydrogen contained therein. The oxidizer steam can be any gaseous stream containing oxygen. In the embodiment of FIG. 1 the gaseous stream released from the cathodes of the fuel cell stacks is used as oxidizer stream and delivered to the combustor 23 through an oxidizer line 25 to burn hydrogen in the combustor 23. Combustion gas from combustor 23 is vented along a venting line 27.

Heat contained in the combustion gas discharged by the combustor 23 can be at least partly recovered in a waste heat recovery unit 29. For instance, heat can be transferred to a waste heat recovery circuit 31, where a heat transfer fluid can circulate and transfer heat to a generic heat load 33.

In some embodiments recovered heat can be used in a low-temperature thermodynamic circuit to convert heat into mechanical power through a thermodynamic cycle, for instance an organic Rankine cycle (ORC).

If the fuel cell unit 3 operates at high temperature, for instance if solid oxide fuel cells are used, further heat can be recovered from the flue gas delivered at the anodes of the fuel cell stacks. A first amount of waste heat from the flue gas can be recovered in a waste heat recovery unit 35 in heat exchange with the oxidant stream flowing in line 7 and used to pre-heat the oxidant stream prior to delivering to the fuel cell unit 3.

A further amount of waste heat can be recovered from the flue gas in a further waste heat recovery unit 37, combined with the waste heat recovery circuit 31.

With continuing reference to FIG. 1, FIG. 2 illustrates in more detail an embodiment of a system according to the present disclosure. The same reference numbers used in FIG. 1 will be used in FIG. 2 to designate the same or equivalent parts.

In FIG. 2 a fuel cell unit 3 is fluidly coupled to a fuel delivery line 5 from a fuel source 9, for instance a methane source. The fuel cell unit 3 includes a first fuel cell stack 301 with an anode 302 and a cathode 303. The fuel cell unit 3 may include additional fuel cell stacks (not shown). The various fuel cell stacks are fed with a fuel stream along a line 305 and an oxidizer stream along a line 307. In the following description reference will be usually made to a single fuel cell stack, for the sake of clarity, but it shall be understood that the fuel cell unit 3 may have a plurality of fuel cell stacks 301 according to needs and based on specific design constraint and requirements.

In some embodiments, the fuel cell unit 3 may include solid oxide fuel cells (SOFCs).

The fuel cells may be capable of internally reforming light hydrocarbons, such as methane, used as fuel for the fuel cell unit 3. In the embodiment illustrated in FIG. 2, however, a separate steam hydrocarbon reforming section 309, specifically a steam methane reforming section 309, is provided. The steam hydrocarbon reforming section 309 is represented as being part of the fuel cell unit 3.

Flue gas discharged at the anode(s) 302 of the fuel cell stack(s) 301 flows in a flue gas line 11 through the steam reforming section 309 to provide heat for the reforming reaction (see eq. (1) above).

In some embodiments, a bypass line 306 may be provided, to deliver a fraction of the flue gas from the anode(s) 302 of the fuel cell stack(s) 301 to an ejector 501 back in the fuel delivery line 5 upstream of the steam reforming section 309.

Air, or another oxidant stream, is delivered through an oxidant inlet line 7. In embodiments, the oxidizing stream is ambient air. The oxidant stream (ambient air) can be delivered to the cathode of the fuel cell stack 301 by a blower 701 driven by a driver 703, for instance an electric motor. In the fuel cell stack 301 the oxygen molecules contained in the oxidant stream delivered to the cathode of the fuel cell stack 301 are converted to oxygen ions which flow through the electrolyte of the fuel cell stack 301 towards the anode 303, where the oxygen ions oxidize the hydrogen, generating electricity which flows through an external circuit schematically shown at 311, which may deliver DC electric current to a DC/AC converter, in turn electrically coupled to an electric power distribution grid (not shown in FIG. 2, see FIG. 1).

In other embodiments, hydrogen ions may migrate through the electrolyte of the fuel cell stack from the anode towards the cathode, where they combine with oxygen. Whether positive hydrogen ions or negative oxygen ions migrate through the electrolyte depend upon the kind of fuel cell used. Irrespective of which species flows through the electrolyte, the net result is a flow of electrons through the external electric circuit. In case of the latter system water may need to be added to the steam methane reforming section 309, taken from the oxidant stream after heat exchange by condensation or from the condensate formed in the flue gas compressor 13.

Through the flue gas line 11 the flue gas from the fuel cell anode 302, mainly containing un-reacted hydrogen, carbon monoxide, carbon dioxide and water, is delivered towards a flue gas compression section 13.

In the embodiment of FIG. 2, the flue gas compression section 13 includes a liquid/gas separator 1301 and a condensate accumulator 1302. Water which condensed in the flue gas is separated from the flue gas in the liquid/gas separator 1301 and collected in the condensate accumulator 1302.

The flue gas compression section 13 further comprises one or more flue gas compressors or compressor stages. In the embodiment of FIG. 2 the compression section 13 comprises a sequence of four compressors 1303, 1304, 1305, 1306, driven by a common driver 1307 through a shaft 1308. The flue gas compression section 13 can further include intercoolers 1310, 1311 and 1312 between sequentially arranged compressors 1303, 1304, 1305, 1306.

Water condensing in the intercoolers 1310, 1311 and 1312 can be collected through condensate ducts 1313, 1314, 1315, 1316 in the condensate accumulator 1302.

The delivery side of the most downstream compressor 1306 of the flue gas compression section 13 is fluidly coupled to a water-gas shift reactor 15. Compressed flue gas delivered by the flue gas compression section 13 flows through a heat exchanger 1501 in the water-gas shift reactor 15, where carbon monoxide contained in the compressed flue gas stream reacts with water vapor and is converted according to eq. (3) into carbon dioxide and hydrogen. If additional water is needed for the water-gas shift reaction, a water deliver line 1502 fluidly connects the condensate accumulator 1302 to the bottom of the water-gas shift reactor 15. A pump 1505 in conjunction with a control valve 1503 may control the water flow towards the water-gas shift reactor 15.

The resulting flue gas from the water-gas shift reactor 15 flows through the heat exchanger 1501 in heat exchange with the flue gas entering the water-gas shift reactor 15 and is further cooled in a heat exchanger 1504.

A flue gas line 1701 fluidly connects the outlet of the water-gas shift reactor 15 to a cryogenic carbon dioxide capture unit 17. By way of non-limiting exemplary embodiments, suitable cryogenic carbon dioxide capture units are disclosed in EP2365265, EP2407741, EP2545977.

In FIG. 2 the cryogenic carbon dioxide capture unit 17 includes a drier 1702, which removes residual water in vapor phase still contained in the flue gas which streams from the water-gas shift reactor 15.

The cryogenic carbon dioxide capture unit 17 further includes an arrangement of heat exchangers, separation drums and pressure reducing devices, such as pressure-reduction valves and/or expanders. The high-temperature flue gas stream flows through the hot side of the heat exchangers in heat exchange with a low-temperature flue gas stream and low-temperature carbon dioxide streams, to remove carbon dioxide by condensation from the incoming flue gas. The separation drums separate liquefied carbon dioxide from the flue gas. The separated carbon dioxide is delivered to a carbon dioxide compression section, possibly including chillers and heat exchangers, to bring the separated carbon dioxide in a liquefied or supercritical phase.

Cold flue gas is obtained by expanding the compressed flue gas in the expanding devices after separation of the liquefied carbon dioxide in the separation drums.

Embodiments of cryogenic carbon dioxide capture units adapted to be used in the system 1 of the present disclosure will be described in more detail here below.

In the embodiment of FIG. 2 the cryogenic carbon dioxide capture unit 17, also referred to as “Gas Processing Unit” (GPU), comprises a so-called “cold box” 170 that contains a first heat exchanger 1703. The first heat exchanger 1703 includes a hot side and three cold sides. Flue gas from the drier 1702 flows through the hot side. Carbon dioxide and chilled carbon dioxide-depleted flue gas flow in the cold sides of the first heat exchanger 1703, as described here after.

The hot side of the first heat exchanger 1703 is fluidly coupled to the outlet of the drier 1702 through a line 1704. The outlet of the hot side of the first heat exchanger 1703 is fluidly coupled through a delivery line 1705 to a first separation drum 1706. The gas outlet of the first separation drum 1706 is fluidly coupled through a line 1707 to a hot side of a second heat exchanger 1708. The outlet of the hot side of the second heat exchanger 1708 is fluidly coupled through a line 1709, to a second separation drum 1710.

In the embodiment of FIG. 2, the second heat exchanger includes two cold sides, where carbon dioxide and carbon dioxide-depleted flue gas flow in heat exchange relationship with the flue gas from line 1707.

The gas outlet of the second separation drum 1710 is fluidly coupled to a line 1711, along which a pressure reduction device 1712 is arranged. In the embodiment of FIG. 2, the pressure reduction device 1712 is a pressure-reduction valve. Carbon diox-ide-depleted flue gas delivered at the top of the second separation drum 1710 expands in the pressure reduction device 1712 and the temperature thereof is thus reduced. The depressurized (expanded) and chilled carbon dioxide-depleted flue gas flows through a first cold side 1713 of the second heat exchanger 1708 and through a first cold side 1714 of the first heat exchanger 1703 in heat exchange with the hot flue gas flowing through the hot side of the heat exchanger 1703 and through the hot side of the second heat exchanger 1708, thus removing heat therefrom.

Liquid carbon dioxide separates from the flue gas in the first separation drum 1706 and collects at the bottom thereof. Further liquid carbon dioxide separates from the flue gas in the second separation drum 1710 and collects at the bottom thereof.

The liquid carbon dioxide from the bottom of the second separation drum 1710 flows through a return line 1715 and through a pressure reduction device 1716 arranged there along, for example a pressure reduction valve, and through a second cold side 1717 of the second heat exchanger 1708, in heat exchange with the flue gas flowing through the hot side of the second heat exchanger 1713.

The carbon dioxide exiting from the second cold side 1717 of the second heat exchanger 1708 further flows through a second cold side 1718 of the first heat exchanger 1703 in heat exchange with the flue gas flowing through the hot side of the first heat exchanger 1703.

Similarly, liquefied carbon dioxide from the bottom of the first separation drum 1706 flows through a return line 1719 and through a pressure reduction device 1720, e.g. a pressure reduction valve, and through a third cold side 1721 of the first heat exchanger 1703, in heat exchange with the flue gas flowing through the hot side of the first heat exchanger 1703.

In short, the expanded (depressurized) carbon dioxide from the bottom of the two separation drums 1710 and 1706 chills the flue gas flowing through the hot side of the two heat exchangers 1703 and 1708. A further chilling action is performed by the expanded flue gas from the top of the second separation drum 1710, such that carbon dioxide contained in the incoming flue gas from the drier 1702 liquefies and separates from the flue gas in the separation drums 1706 and 1710.

The carbon dioxide-depleted flue gas collected at the top of the second separation drum 1710 is recycled through a recycle line 21 towards the fuel delivery line 5. The carbon dioxide-depleted flue gas in recycle line 21 contains hydrogen generated in the water-gas shift reactor 15 and residual hydrogen from the anode 302 of the fuel cell stack 301.

The carbon dioxide exiting the cold sides 1721 and 1718 of the first heat exchanger 1703 is pressurized in a carbon dioxide compression section 1725 and removed through a carbon dioxide discharge line 19.

In the embodiment of FIG. 2 the carbon dioxide compression section 1725 includes a set of carbon dioxide compressors 1727, 1728 and 1729, arranged in series. An intercooler can be provided between the carbon dioxide compressors. In the embodiment of FIG. 2, a single intercooler 1730 is shown between the second compressor 1728 and the third compressor 1729. The carbon dioxide compressors 1727, 1728 and 1729 can be driven by a driver 1731, for instance an electric motor, through a shaft 1732. The carbon dioxide from the bottom of the first separation drum 1706 is at a higher pressure than the carbon dioxide from the second separation drum 1710. Therefore, the carbon dioxide stream from the first separation drum 1706 is delivered to the suction side of the intermediate the compressor 1728, while the carbo dioxide stream from the second separation drum 1710 is delivered to the suction side of the most upstream compressor 1727.

In summary: the flue gas from the fuel cell unit 3 is processed in the water-gas shift reactor 15 such that carbon monoxide and water are converted into hydrogen and carbon dioxide. Carbon dioxide is captured and removed from the flue gas and the carbon dioxide-depleted flue gas, which contains hydrogen, is recycled through recycle line 21 towards the fuel cell unit 3 for further reaction with oxygen in the fuel cell stacks.

To prevent accumulation of inert gases in the system, a fraction of the recycled flue gas is withdrawn from the recycle line 21 though a diverting line 22 to a combustor 23. The combustor 23 is further adapted to receive an oxidizer stream to oxidize the hydrogen contained in the diverted stream and generate heat therewith.

In the embodiment of FIG. 2 the oxidizer stream is delivered through an oxidizer line 25, which fluidly connects the combustor 23 to the cathode 303 of the fuel cell stack 301, to receive gas discharged from the cathode 303, that contains residual atmospheric oxygen. The combustion gas generated in the combustor 23 is discharged through a venting line 27.

To further increase the energetic efficiency of the system 1, a waste heat recovery unit 29 is provided along the venting line 27, wherewith heat is recovered from the combustion gas and transferred to a heat transfer circuit 31. A generic heat load 33 can be powered with heat waste heat recovered through the waste heat recovery unit 29. As mentioned with regard to the simplified schematic of FIG. 1, the waste heat recovered through the waste heat recovery unit 29 can be exploited in a bottom thermodynamic cycle, for instance an organic Rankine cycle, to convert heat into mechanical power and optionally into electric power through an electric generator driven by an expander. Alternatively, the waste heat recovery units 29 and 37 can be operated in conjunction with district heating systems or other hot liquid fluid cycles.

To further increase the efficiency of the system 1, along the venting line 27 a further waste heat recovery unit 30 can be provided, upstream of the waste heat recovery unit 29 with respect to the direction of flow of the combustion gas. The waste heat recovery unit 30 is adapted to transfer heat from the combustion gas discharged by the combustor 23 to the air stream processed through the blower 701 prior to reaching the fuel cell cathode 303.

In the embodiment of FIG. 2, the oxidant stream (air stream from air blower 701) is split in a main oxidant stream flowing through line 7 and a secondary oxidant stream flowing in a secondary oxidant stream line 705, which extends through the waste heat recovery unit 30, in heat exchange relationship with the combustion gas from the combustor 23. In this way, the oxidant stream delivered to the fuel cell unit 3 is partly pre-heated by waste heat recovered from the combustion gas discharged by the combustor 23 through the waste heat recovery unit 30; and partly pre-heated by heat exchange in a waste heat recovery unit 35, where the oxidant stream receives heat from the flue gas discharged from the anode 302 of the fuel cell stack 301 and flowing through the steam methane reforming section 309.

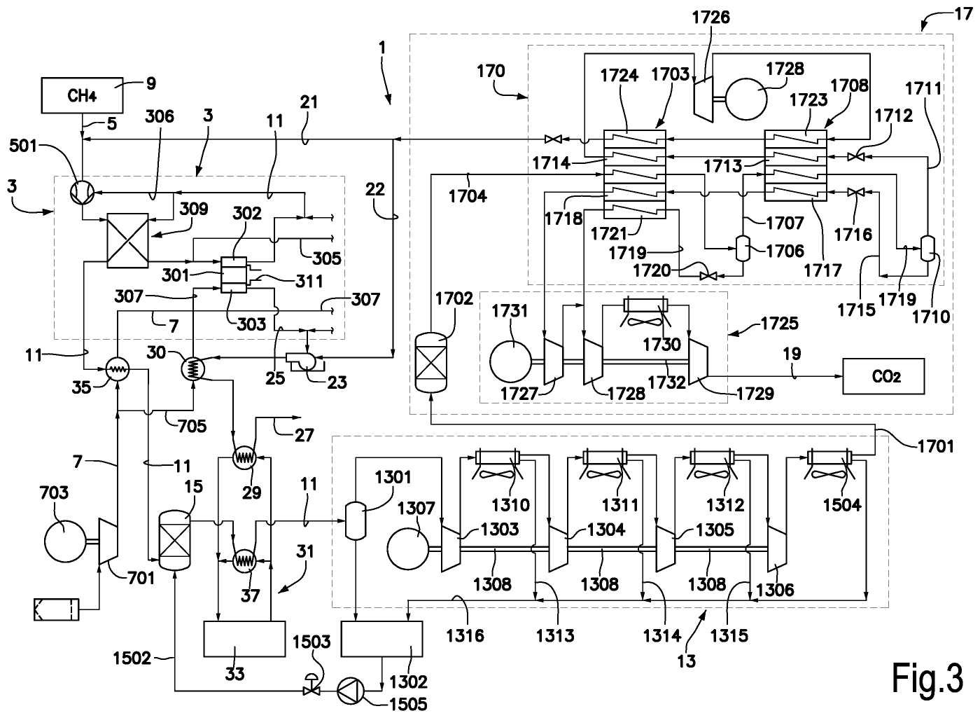

With continuing reference to FIGS. 1 and 2, a further embodiment of a system according to the present disclosure is illustrated in FIG. 3. The same reference numbers indicate the same elements as shown in FIGS. 1 and 2, which will not be described again.

The main difference between the embodiments of FIGS. 2 and 3 concerns the position of the water-gas shift reactor 15. As described above, the water-gas shift reactor 15 is aimed at converting carbon monoxide and water into carbon dioxide and hydrogen. Carbon dioxide is then captured and removed from the flue gas, while hydrogen contained in the carbon dioxide-depleted flue gas is used in the fuel cell unit 3 by recycling the carbon dioxide-depleted flue gas to the fuel cell unit 3.

While in FIG. 2 the water-gas shift reactor 15 is positioned downstream the discharge side of the flue gas compression section 13, in the embodiment of FIG. 3 the water-gas shift reactor 15 is arranged upstream of the suction side of the flue gas compression section 13, and more specifically between the waste heat recovery unit 35 and the waste heat recovery unit 37.

FIG. 3 also shows a different configuration of the cryogenic carbon dioxide capture unit 17. Compared with FIG. 2, in FIG. 3 the second heat exchanger 1708 comprises a further cold side 1723 fluidly coupled to the outlet of the first cold side 1714 of the first heat exchanger. Additionally, the first heat exchanger 1703 comprises a further cold side 1724 fluidly coupled to the outlet of the further cold side 1723 of the second heat exchanger 1708. Between the outlet of the first cold side 1714 of the first heat exchanger 1703 and the inlet of the further cold side 1723 of the second heat exchanger an expander 1726 is provided.

The carbon dioxide-depleted flue gas exiting from the top of the second separation drum 1710 flows sequentially through the pressure reduction device (pressure reduction valve) 1712, the first cold side 1713 of the second heat exchanger 1708, the first cold side 1714 of the first heat exchanger 1703, the expander 1726, the further cold side 1723 of the second heat exchanger 1708 and finally towards the fuel cell unit 3 through recycle line 21. Flue gas expansion in expander 1726 can be used to drive an electric generator 1728 and generate electric power therewith.

In further embodiments, not shown, the water-gas shift reactor 15 can be arranged as in FIG. 2 and the cryogenic carbon dioxide capture unit 17 can be configured as in FIG. 3. In yet further embodiments, not shown, the water-gas shift reactor 15 can be arranged as in FIG. 3 and the cryogenic carbon dioxide capture unit 17 can be configured as in FIG. 2.

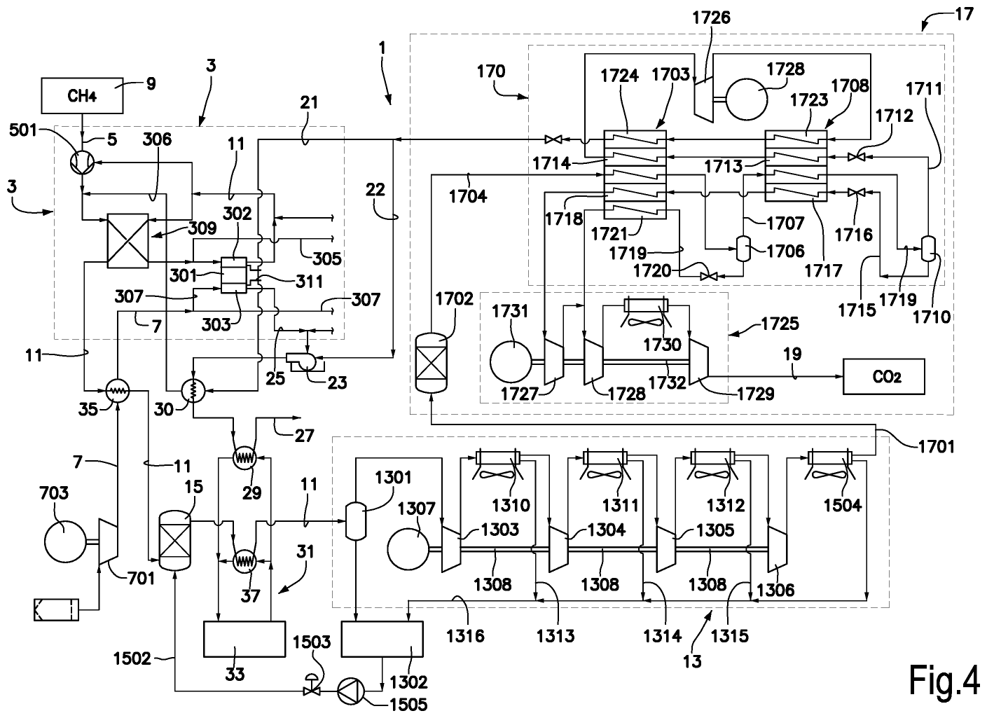

With continuing reference to FIGS. 1, 2 and 3, a further embodiment of a system according to the present disclosure is shown in FIG. 4. The same reference numbers indicate the same elements as shown in FIGS. 1, 2 and 3, which will not be described again. The main difference of the embodiment of FIG. 3 with respect to the embodiment of FIG. 3 regards the waste heat recovery from the combustion gas discharged by the combustor 23. In FIG. 4 the waste heat recovery unit 30 is used to transfer heat from the combustion gas to the recycled carbon dioxide-depleted flue gas, which flows through the recycle line 21.

Differently from the embodiments of FIGS. 2 and 3, in FIG. 4 the oxidant stream delivered by the blower 701 is not split into a main and a secondary stream line 7 and 705, as shown in FIGS. 2 and 3, but flows entirely through a single oxidant stream line 7 to the cathode 303 of the fuel cell stack 301 and is pre-heated before reaching the fuel cell unit 3 only by heat removed from the flue gas through the waste heat recovery unit 35.

In yet further embodiments, not shown, the heat recovery arrangement of FIG. 4 can be combined with a system where the water-gas shift reactor is arranged as shown in FIG. 2 and the cryogenic carbon dioxide capture unit 17 is configured as shown in FIG. 2. In further embodiments, the heat recovery arrangement of FIG. 4 can be used in a system where the water-gas shift reactor is arranged as in FIGS. 3 and 4 but and the cryogenic carbon dioxide capture unit 17 is configured as configured in FIG. 2.

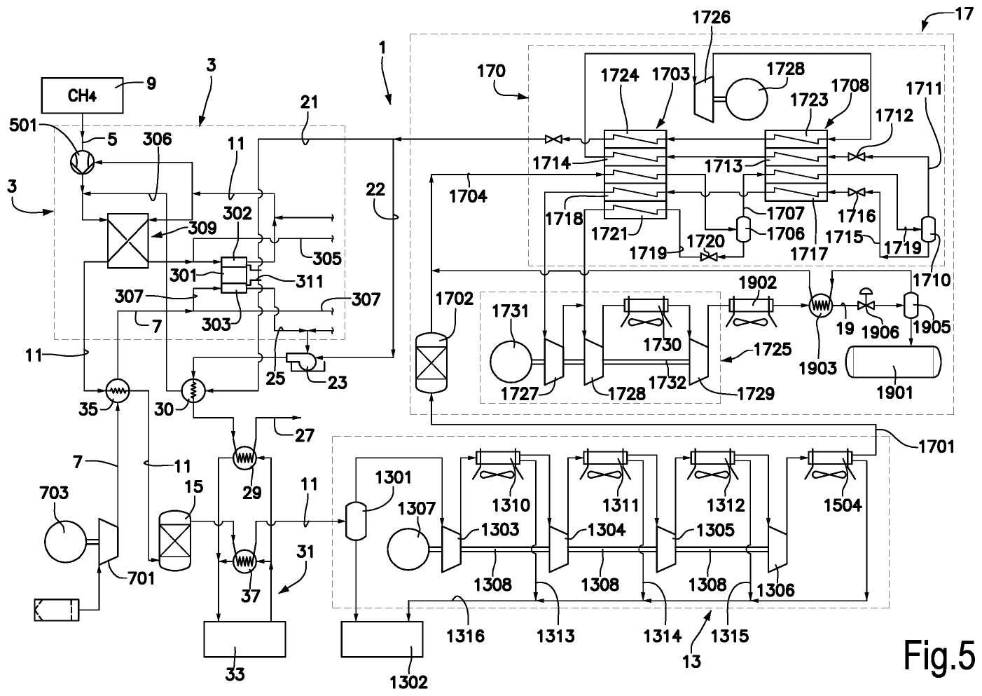

With continuing reference to FIGS. 1, 2, 3 and 4, a yet further embodiment is shown in FIG. 5. The same reference numbers indicate the same elements as shown in FIGS. 1, 2, 3 and 4, which will not be described again. The layout of the system 1 shown in FIG. 5 substantially corresponds to the layout of FIG. 4. The main difference concerns the collection of carbon dioxide removed from the flue gas and compressed in the carbon dioxide compression section 1725. In the embodiment of FIG. 5, the compressed carbon dioxide delivered at the delivery side of the carbon dioxide compression section 1725 is liquefied and collected in a vessel 1901. This requires cooling of the compressed carbon dioxide in a cooler 1902 arranged downstream of the carbon dioxide compressor section 1725 and in a heat exchanger 1903. In the heat exchanger 1903 the compressed carbon dioxide is chilled in heat exchange with a flow of gaseous carbon dioxide collected at the top of an additional separation drum 1905. The carbon dioxide chilled in the heat exchanger 1903 is expanded in a pressure control and reduction valve 1906 and finally delivered to the additional separation drum 1905. The liquid carbon dioxide collecting at the bottom of the additional separation drum 1905 is collected in the vessel 1901, while the gaseous carbon dioxide collected at the top of the additional separation drum 1905 is returned through the heat exchanger 1903 into the line 1704.

In other embodiments, not shown, the carbon dioxide liquefaction arrangement of FIG. 5 can be combined with a different layout of the cryogenic carbon dioxide capture unit 17, for instance as shown in FIG. 2 and/or with a water-gas shift reactor arranged as in FIG. 2.

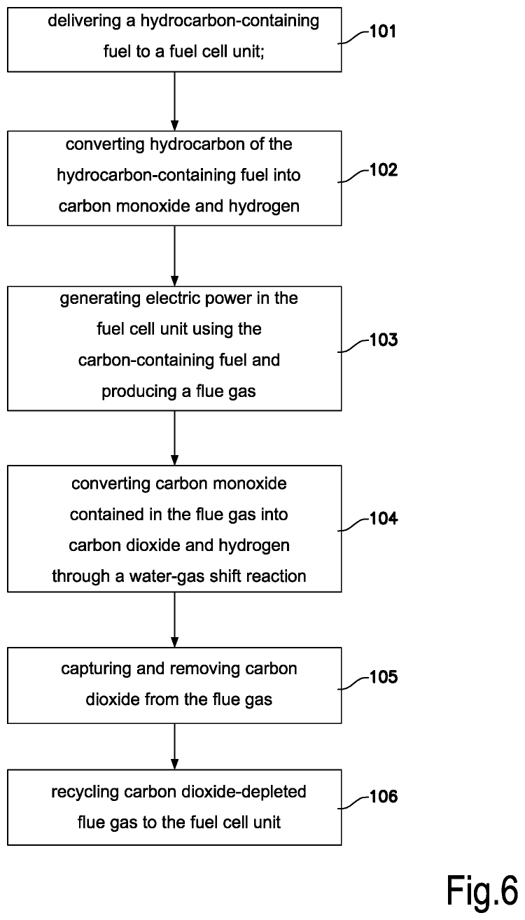

In general terms, and irrespective of the specific arrangement or layout, the system disclosed herein is adapted to generate power, specifically electric and possibly thermal power, with high efficiency and low carbon dioxide emission using fossil fuels, and specifically natural gas as a fuel in a fuel cell unit. The flowchart of FIG. 6 summarizes a method according to the present disclosure. Specifically, in step 101 fuel containing a hydrocarbon, such as methane, is delivered to the fuel cell unit; in step 102 the hydrocarbon is converted into carbon monoxide and hydrogen by hydrocarbon reforming. Subsequently (step 103) electric power is generated in the fuel cell stack(s) of the fuel cell unit using the hydrogen obtained by reforming. In step 105 carbon monoxide generated by reforming of the hydrocarbon is converted by water-gas shift reaction into carbon dioxide and hydrogen. After removing of carbon dioxide from the flue gas (step 105), the carbon dioxide-depleted flue gas is recycled towards the fuel cell unit (step 106).

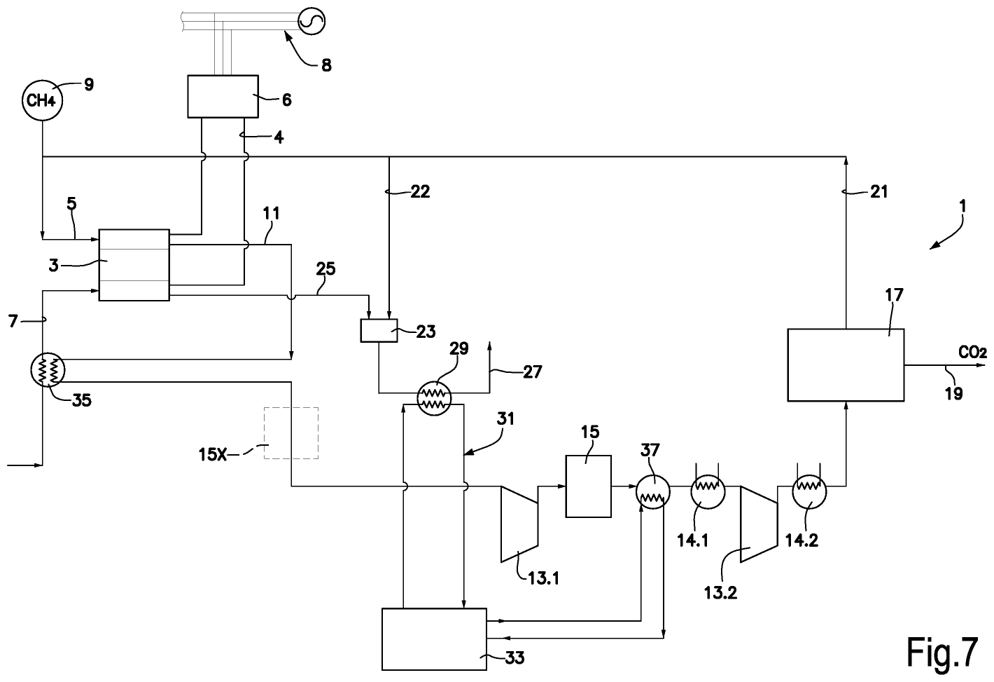

FIG. 7 is a schematic diagram of a further embodiment of a system according to the present disclosure. The same reference numbers designate the same components as in FIG. 1. These components will not be described in detail again.

In FIG. 7 the flue gas compression section 13 comprises a first compressor 13.1 and a second compressor 13.2 in sequence. The delivery side of the first compressor 13.1 is fluidly coupled to the suction side of the second compressor 13.2. An intercooler 14.1 is positioned between the first compressor 13.1 and the second compressor 13.2. The flue gas is partly compressed in the first compressor 13.1 and further compressed in the second compressor 13.2. The intercooler 14.1 cools the partially compressed flue gas before further compression in the second compressor 13.2

In the embodiment of FIG. 7 the water-gas shift reactor 15 is positioned between the delivery side of the first compressor 13.1 and the intercooler 14.1. The flue gas is therefore heated by compression in the first compressor 13.1 and the temperature thereof is increased such that the flue gas enters the water-gas shift reactor 15 at a higher temperature which increases the efficiency of the water-shift reaction without the need to supply thermal energy from an external source. To further enhance the water-gas shift reaction efficiency, the waste heat recovery unit 37 is moved downstream to the outlet of the water-gas shift reactor 15, namely between the flue gas compressor and the cryogenic carbon dioxide capture unit. In the embodiment of FIG. 7 the waste heat recovery unit 37 is arranged between the outlet of the water-gas shift reactor 15 and an intercooler 14.1 positioned upstream of the second compressor 13.2. In some embodiments, a further cooler 14.2 can be arranged between the delivery side of the second compressor 13.2 and the cryogenic carbon dioxide capture unit 17.

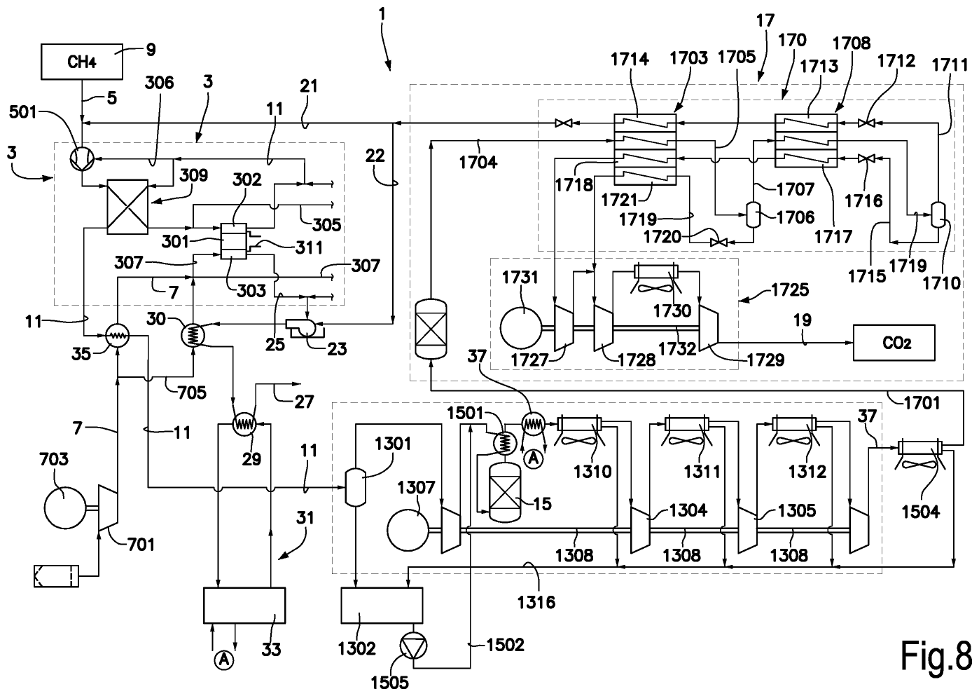

A more detailed schematic of an embodiment of a system according to FIG. 7 is shown in FIG. 8. The elements, parts or components of FIG. 8 which correspond to elements, parts or components shown in FIGS. 2 to 5 are labeled with the same reference numbers and will not be described in detail again.

In FIG. 8 the water-gas shift reactor 15 is arranged along the flue gas path between the first flue gas compressor 1303 and the intercooler 1310, which is located between the first flue gas compressor 1303 and the second flue gas compressor 1304. Quite in the same way as in FIG. 2, partially compressed flue gas delivered by the first flue gas compressor 1303 flows through a heat exchanger 1501 in the water-gas shift reactor 15, where carbon monoxide contained in the partly compressed flue gas stream reacts with steam and is converted according to eq. (3) into carbon dioxide and hydrogen. A water deliver line 1502 fluidly connects a condensate accumulator 1302 to the bottom of the water-gas shift reactor 15. A pump 1505 in conjunction with a control valve 1503 may control the water flow towards the water-gas shift reactor 15 and deliver additional water to the water-gas shift reactor 15. The water flow from the condensate accumulator 1302 can adjust the water/carbon monoxide ratio and the reaction temperature in the water-gas shift reactor 15. As mentioned in connection with FIG. 7, by arranging the water-gas shift reactor 15 between the first compressor 1303 and the first intercooler 1310, compression heat can be exploited to enhance the water-gas shift reaction.

Moreover, since less or no steam is condensed upstream of the water-gas shift reactor 15, but rather the entire steam contained in the flue gas from the fuel cell unit 3 is available in the flue gas stream flowing into the water-gas shift reactor 15, a further reduction in thermal power required to run the water-gas shift reactor 15 is obtained.

Waste heat available in the compressed flue gas downstream of the water-gas shift reactor 15 can be recovered in a waste heat recovery unit 37 arranged along the flue gas line, in any position between the water-gas shift reactor 15 and the cryogenic carbon dioxide capture unit 17. In the embodiment of FIG. 8 the waste heat recovery unit 37 is positioned between the outlet of the WGS reactor 15 and the intercooler 1310, where flue gas at the highest temperature after the water-gas shift reaction is available.

The position of the water-gas shift reactor 15 between the first compressor 1303 and the second compressor 1304 can be provided also in the embodiments of FIGS. 3 to 5.

Exemplary embodiments have been disclosed above and illustrated in the accompanying drawings. It will be understood by those skilled in the art that various changes, omissions and additions may be made to that which is specifically disclosed herein without departing from the scope of the invention as defined in the following claims.

1-24. (canceled)

25. A power generation system comprising:
a fuel cell unit adapted to generate electric power using a hydrocarbon-containing gas; wherein the fuel cell unit comprises at least a fuel cell stack with an anode and a cathode;
a water-gas shift reactor adapted to receive flue gas form the fuel cell unit and convert carbon monoxide contained in the flue gas into carbon dioxide and hydrogen;
a cryogenic carbon dioxide capture unit, adapted to receive flue gas from the water-gas shift reactor and remove carbon dioxide therefrom; wherein the cryogenic carbon dioxide capture unit is adapted to produce a stream of carbon dioxide and a stream of carbon dioxide depleted flue gas containing hydrogen;
a flue gas compression section adapted to receive flue gas from the fuel cell unit and deliver compressed flue gas to the cryogenic carbon dioxide capture unit;
a recycle line connecting the cryogenic carbon dioxide capture unit and the fuel cell unit and adapted to recycle the carbon dioxide-depleted flue gas containing hydrogen to the fuel cell unit.

26. The power generation system of claim 25, wherein the fuel cell unit includes a hydrocarbon reforming section adapted to generate hydrogen and carbon monoxide from the hydrocarbon-containing gas.

27. The power generation system of claim 25, wherein the water-gas shift reactor is arranged between a delivery side of the flue gas compression section and the cryogenic carbon dioxide capture unit or between the fuel cell unit and a suction side of the flue gas compression section.

28. The power generation system of claim 25, wherein the flue gas compression section comprises a first compressor, a second compressor and an intercooler between the first compressor and the second compressor; and wherein the water-gas shift reactor is arranged between a delivery side of the first compressor and the intercooler.

29. The power generation system of claim 25, further comprising:
a liquid/gas separator upstream of the flue gas compression section, to remove water from the flue gas prior to compression thereof in the compression unit; and
a condensate accumulator adapted to accumulate water from the liquid/gas separator.

30. The power generation system of claim 29, further comprising a condensate accumulator adapted to collect condensate water from the intercooler; and wherein the water-gas shift reactor is fluidly coupled to the condensate accumulator to receive water therefrom.

31. The power generation system of claim 25, further comprising a venting line, adapted to vent a fraction of the carbon dioxide-depleted flue gas, which is recycled through the recycle line from the cryogenic carbon dioxide capture unit to the fuel cell unit.

32. The power generation system of claim 31, wherein the venting line is fluidly coupled to a combustor; wherein the combustor is fluidly coupled to an oxidizer line adapted to deliver an oxidizer stream to the combustor; and wherein the combustor is adapted to oxidize the vented gas from the venting line and generate thermal power therewith.

33. The power generation system of claim 32, wherein the oxidizer line is fluidly coupled to the cathode of the fuel cell stack to receive oxygen therefrom.

34. The power generation system of claim 32, comprising at least a first waste heat recovery unit adapted to recover waste heat from combustion gas discharged by the combustor; and wherein the first waste heat recovery unit is adapted to transfer waste heat from the combustion gas to at least one of: a heat recovery circuit thermally coupled to a heat load; the recycle line; an oxidant stream line fluidly coupled to the cathode of the fuel cell stack.

35. The power generation system of claim 25 further comprising a second waste heat recovery unit adapted to recover waste heat from the flue gas discharged at the anode of the fuel cell stack.

36. The power generation unit of claim 25, further comprising:
an oxidant feed line, fluidly coupled to the cathode of the fuel cell stack and adapted to deliver an oxidant-containing gaseous stream to the fuel cell stack; and
a heat exchanger adapted to transfer heat from the flue gas delivered by the anode of the fuel cell stack to the incoming oxidant-containing gaseous stream in the oxidant feed line.

37. The power generation unit of claim 25, wherein the cryogenic carbon dioxide capture unit includes at least a separator drum, a heat exchanger and a pressure reducing device.

38. A method for generating power from natural gas, the method comprising the following steps:
delivering a hydrocarbon-containing fuel to a fuel cell unit;
converting hydrocarbon of the hydrocarbon-containing fuel into carbon monoxide and hydrogen;
generating electric power in the fuel cell unit using the hydrogen and an oxidant, and producing a carbon monoxide-containing flue gas;
converting carbon monoxide in the flue gas into carbon dioxide and hydrogen through a water-gas shift reaction;
compressing the flue gas before or after said water-gas shift reaction;
cryogenically capturing and removing carbon dioxide from the compressed flue gas in a cryogenic carbon dioxide capture unit;
recycling carbon dioxide-depleted flue gas containing hydrogen from the cryogenic carbon dioxide capture unit to the fuel cell unit.

39. The method of claim 38, wherein the step of compressing the flue gas comprises the following steps:
compressing the flue gas in a first compressor;
cooling the partially compressed flue gas in an intercooler;
further compressing the partially compressed and cooled flue gas in a second compressor;
wherein the step of converting carbon monoxide into carbon dioxide and hydrogen through the water-gas shift reaction is performed in a water-gas shift reactor arranged between the first compressor and the intercooler.

40. The method of claim 38, further comprising the step of preheating an oxidant flow delivered to the fuel cell unit by heat exchange with the flue gas.

41. The method of one or more of claim 38, further comprising the following steps:
withdrawing a part of the carbon dioxide-depleted flue gas recycling towards the fuel cell unit;
combusting the withdrawn carbon dioxide-depleted flue gas in a combustor generating combustion gas;
recovering waste heat form the combustion gas discharged from the combustor.

42. The method of claim 41, wherein the step of recovering heat from the combustion gas comprises at least one of the following steps:
pre-heating an oxidant stream flowing to the fuel cell unit;
pre-heating the carbon dioxide depleted flue gas recycling towards the fuel cell unit;
transferring heat to a heat recovery circuit thermally coupled to a heat load.

43. The method of claim 38, further comprising the step of recovering waste heat from the flue gas.
